(19) United States
(12) Patent Application Publication
(10) Pub. No.: US 2010/0055405 A1
(43) Pub. Date: Mar. 4, 2010

(54) Tile laying mat

(75) Inventor: Werner Schlueter, Iserlohn (DE)

Correspondence Address: COLLARD & ROE, P.C., 1077 NORTHERN BOULEVARD, ROSLYN, NY, 11576, US

(73) Assignee: Schlueter-Systems KG

(21) Appl. No.: 12/584,124

(22) Filed: Aug. 31, 2009

(30) Foreign Application Priority Data
Sep. 1, 2008 (DE) 10 2008 045 122.3

(51) Int. Cl. B32B 3/10; B29C 43/00

(52) U.S. Cl. 428/156; 264/319

(57) ABSTRACT

Moisture-permeable tile laying mat having a moisture absorption layer having a thickness of at least 1 mm, which mat has a top and an underside as well as a plurality of recesses that extend in the direction of the underside, proceeding from the top.

### CROSS REFERENCE TO RELATED APPLICATIONS

Applicant claims priority under 35 U.S.C. §119 of German Application No. 10 2008 045 122.3 filed Sep. 1, 2008.

### BACKGROUND OF THE INVENTION

1. Field of the Invention

The present invention relates to a tile laying mat for laying tiles on a substratum. In the following, the term tiles is used as a general term for all hard floor coverings made of ceramic, natural stone, or minerally bonded tiles and panels, and for rigid floor covering material that does not bend, made of plastics or wood materials.

2. The Prior Art

Tile laying mats of the aforementioned type are known in the state of the art, in different embodiments.

For example, DE 37 01 414 A1 discloses a tile laying mat having a plastic panel that has a profile consisting of swallowtail-shaped crosspieces and swallowtail-shaped grooves that are parallel to one another and alternate, and having an attachment layer connected with the underside of the plastic panel, for attaching the tile laying mat to a substratum, whereby the attachment layer is formed by a coarse-mesh nonwoven net. In order to lay tiles using this tile laying mat, first the wall or floor substratum on which the tiles are to be laid is covered with a layer of adhesive or mortar, respectively. Then, the tile laying mat is glued to the substratum using the coarse-mesh nonwoven net disposed in its underside. The swallowtail-shaped grooves of the plastic panel, which are directed toward the underside, and are filled only in part with adhesive or mortar, form pressure equalization spaces that serve to compensate stresses that occur in the finished floor composite, between the substratum and the tiles, and to carry away moisture that rises from the substratum or from the adhesive or mortar layer into the tile laying mat. After the tile laying mat is attached to the substratum, another layer of adhesive or mortar is applied to the top of the plastic panel, whereby the adhesive or the mortar becomes wedged into the swallowtail-shaped grooves that are open toward the top of the plastic panel. In this manner, in the dried state of the adhesive or mortar, a firm hold between the plastic panel and the layer of adhesive or mortar is produced. After the layer of adhesive or mortar is applied, tiles can now be laid on the top of the tile laying mat.

Accordingly, a tile laying mat is made available with DE 37 01 414 A1 that has both an uncoupling function and a drainage function. A significant disadvantage of this tile laying mat consists in that although moisture that rises up from below, in the direction of the tile laying mat, can be collected and drained off in the pressure equalization spaces formed by the swallowtail-shaped grooves of the plastic panel that are directed toward the underside, moisture that is present in the layer of adhesive or mortar between the tile laying mat and the tiles cannot. This particularly represents a problem when tiles that have a very large area and do not allow moisture to pass through are used, so that it is not sufficient to pass moisture out through the joins that are present between the tiles. Accordingly, the adhesive between the tile laying mat and the tiles cannot dry sufficiently, and this can lead to loosening of the tiles, depending on the type of adhesive used or on temperature variations to which the composite is exposed.

Another tile laying mat is disclosed in EP 1 712 695 A2. This tile laying mat comprises a film-like plastic panel having support elements that project relative to the top of the mat, are capable of support, and are hollow toward the underside, disposed in a uniform area distribution, and partly undercut, whereby open channels that carry water away are formed between the support elements. A water-permeable and vapor-permeable nonwoven or woven-fabric-like cover is disposed on the support elements. In order to lay tiles using this tile laying mat, the laying mat is embedded on the substratum, in the region of its lower contact surfaces, in a thin-bed mortar layer that is still soft and is hardening, whereby the mortar anchors itself in the undercuts of the support elements, which are configured in undercut form, thereby producing a firm connection between the substratum and the tile laying mat. Then, the ceramic panels are laid directly on the nonwoven-type cover disposed on the top of the tile laying mat, using a thin-bed mortar layer, and attached, whereby the mortar engages into the nonwoven, so that the tiles are securely held on the tile laying mat. In the case of this tile laying mat, moisture that is present in the thin-bed mortar layer disposed between the tile laying mat and the tiles can get into the water-draining channels by means of the nonwoven or woven-fabric-like cover, and be drained away via these channels. In contrast, moisture that comes from below cannot penetrate the film-like plastic panel, and for this reason, drainage of moisture from the substratum or from the thin-bed mortar layer disposed underneath the tile laying mat is not possible.

### SUMMARY OF THE INVENTION

Proceeding from this state of the art, it is a task of the present invention to create a tile laying mat having an alternative structure. In particular, a tile laying mat is to be made available that permits removal of moisture on both sides, even when using tiles that have a large area and are impermeable to moisture.

This task is accomplished, according to the present invention, by means of a tile laying mat according to claim 1, and by a method for the production of such a mat, according to claim 19. The dependent claims relate to individual embodiments of the present invention.

The tile laying mat according to the present invention is a moisture-permeable mat, in other words a mat that allows water to pass through in the liquid and/or in the vapor-form state, both from above and from below, in the installed state in accordance with its purpose. In order to absorb moisture that penetrates into the tile laying mat, the mat comprises a moisture absorption layer that has a thickness of at least 1 mm, in order to ensure a sufficient moisture absorption volume. This moisture absorption layer is preferably not only moisture-permeable but also moisture-wicking and/or moisture-equalizing. Accordingly, the moisture absorbed in it is uniformly distributed and/or drained away. Furthermore, the moisture absorption layer is preferably configured to be air-permeable and/or heat-insulating and/or noise-insulating.

The moisture absorption layer furthermore has a plurality of recesses that extend from the top in the direction of the underside. These recesses, which are preferably disposed distributed uniformly over the entire area of the tile laying mat, are filled with adhesive or mortar when the tiles are laid, thereby forming support stilts that absorb those forces that are exerted on the tiles, and pass them on to the substratum. These support stilts furthermore prevent the moisture absorption volume that is made available by the moisture absorption layer from being reduced by the forces that act on the tiles. They therefore serve as spacers that counteract compression of the moisture absorption layer, and accordingly ensure the proper moisture absorption function of the tile laying mat.

If the tile laying mat is supposed to perform not only its moisture absorption function but also an uncoupling function, then it is important that the recesses do not penetrate the underside of the tile laying mat. In other words, the recesses are not allowed to form any passage holes. Accordingly, the support stilts formed by the recesses are prevented from making a connection with the layer of adhesive or mortar disposed underneath the tile laying mat, and no direct coupling is produced.

Furthermore, in order to achieve an uncoupling function, it is advantageous if the load absorption stilts can move within the recesses—if necessary with displacement of adjacent regions of the moisture absorption layer. In this manner, shear forces that occur between the substratum and the tiles, for example, can be compensated; in the long run, these could lead to loosening of the tiles. For this purpose, the bottom and/or side walls of the recesses are advantageously configured, at least in part, in such a manner that no adhesive connection between them and a tile adhesive introduced into the recesses or between them and the load absorption stilts occurs. Preferably, the bottom and/or side walls of the recesses are structured in the form of a smooth plastic surface that prevents an adhesive connection between the bottom and/or side walls of the recesses and the tile adhesive.

It is advantageous if the moisture absorption layer is configured in nonwoven or woven-fabric-like manner, and has a corresponding elasticity. It preferably comprises plastic filaments having the same or a different structure, particularly polyester filaments, which can be disposed in regular manner, with a predetermined orientation, and/or in the form of a woven fabric, or in irregular manner, as an interlaid scrim.

Preferably, an attachment layer is connected with the underside and/or top of the moisture absorption layer, particularly glued to it. In this connection, the underside or top of the attachment layer is preferably configured in such a manner that it enters into an adhesive connection with a tile adhesive. In particular, for this purpose, the attachment layer can be configured in the manner of a nonwoven, a woven fabric, or a lattice. In this connection, the attachment layer should prevent overly deep penetration of the adhesive into the moisture absorption layer, in order not to impair the function of the moisture absorption layer.

According to an embodiment of the present invention, the moisture absorption layer is a pile textile layer of a spacer knitted fabric disposed between a lower and an upper cover textile layer. Such spacer knitted fabrics are already known in other connections in the state of the art, and particularly serve for cushioning objects, such as bicycle helmets, shoe soles, or the like. They are primarily produced from polyamides and polyesters, and offer very good heat and moisture regulation because of the cavities that are present between the filaments of such a knitted fabric. These spacer knitted fabrics can be produced in different thicknesses. For the present purpose of use, spacer knitted fabrics having a thickness of 1 mm and more are preferred. The defined distance between the two cover textile layers of the spacer knitted fabric is normally achieved by means of the pressure-elastic filaments (pile filaments). The use of such spacer knitted fabrics as a carrier for ceramic panels thus guarantees both a good drainage function and a good heat insulation function. Furthermore, if desired, an uncoupling function can be implemented.

According to an embodiment of the present invention, the underside of the lower cover textile layer and/or the top of the upper cover textile layer is/are configured in the manner of a nonwoven, in order to achieve a good adhesive connection between the underside of the lower cover textile layer and an adhesive. According to an alternative embodiment of the present invention, an attachment layer is connected with the underside of the lower cover textile layer and/or with the top of the upper cover textile layer, particularly glued to it, the underside/top of which attachment layer, i.e. its side that faces out, is configured in such a manner that it enters into an adhesive connection with a tile adhesive, to attach the tile laying mat. In this connection, the side of the attachment layer that faces outward is advantageously configured in the manner of a nonwoven, in order to achieve the desired adhesive connection.

In total, the tile laying mat preferably has a thickness in the range of 1-5 mm. Furthermore, it is advantageous if the mat is configured in such a flexible manner that it can be rolled up. of course, it can also have a greater thickness, for example if good air circulation is supposed to be guaranteed when tiles are mounted on wall or ceiling surfaces.

It is advantageous if the tile laying mat is configured in such tear-resistant manner that it can be attached to walls and ceilings with attachment means, particularly anchor bolts and screws.

Furthermore, the present invention creates a method for the production of a tile laying mat of the type defined above.

It is advantageous if the method contains the step that the recesses of the moisture absorption layer are configured with partial melting of at least the moisture absorption layer, thereby producing smooth bottom and/or side walls that prevent an adhesive connection with a tile adhesive. In this connection, it is advantageous if the recesses are formed in the tile laying mat using hot punches of a molding die.

### BRIEF DESCRIPTION OF THE DRAWINGS

In the following, preferred embodiments of the present invention are described in greater detail, making reference to the attached drawing, in which:

FIG. 1 is a top view of a tile laying mat according to a first embodiment of the present invention;

FIG. 2 is a sectional view of the tile laying mat along the section line II-II in FIG. 1;

FIG. 3 is a sectional view through a floor composite that shows the tile laying mat shown in FIGS. 1 and 2 in the laid state;

FIG. 4 is a sectional view corresponding to FIG. 2 of a tile laying mat according to a second embodiment of the present invention;

FIG. 5 is a sectional view corresponding to FIG. 2 of a tile laying mat according to a third embodiment of the present invention; and

FIG. 6 is a sectional view corresponding to FIG. 2 of a tile laying mat according to a fourth embodiment of the present invention.

### DETAILED DESCRIPTION OF PREFERRED EMBODIMENTS

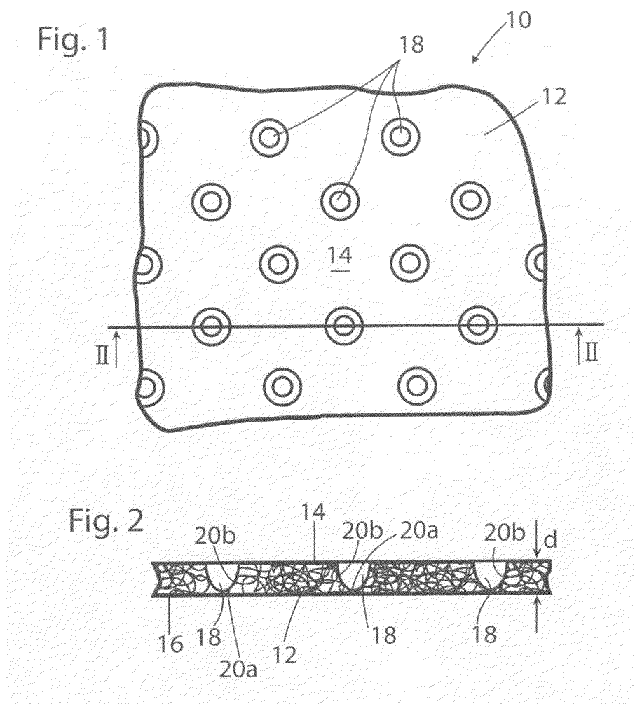

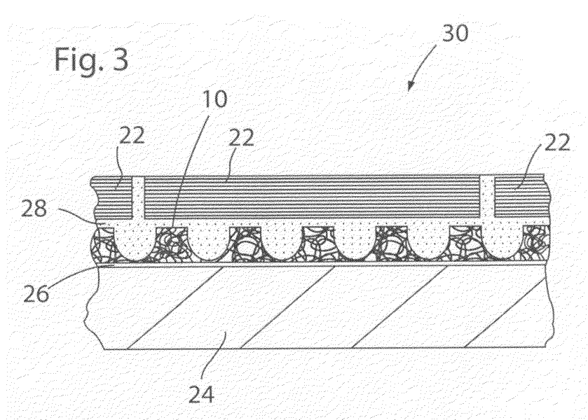

FIGS. 1 to 3 show a tile laying mat 10 according to a first embodiment of the present invention, whereby FIGS. 1 and 2 show the tile laying mat 10 itself, while FIG. 3 shows the tile laying mat 10 shown in FIGS. 1 and 2 in the laid state. The tile laying mat 10, which can be configured in the manner of a panel, strip, or carpet, comprises a moisture-permeable moisture absorption layer 12 configured in the manner of a nonwoven. The moisture absorption layer 12 has a plurality of plastic filaments disposed in irregular manner, in the manner of an interlaid scrim, for example polyester filaments that are at least partly connected with one another, and accordingly produce a cohesive mat-like composite having a top 14 and an underside 16. The moisture absorption layer furthermore comprises a plurality of recesses 18 that extend in the direction of the underside 16, proceeding from the top 14, but do not penetrate it. The recesses 18 have a circular cross-section that narrows conically from the top to the bottom, thereby forming upside-down truncated cone shapes. These recesses 18 are produced in that hot punches of a molding die, whose ends have a negative contour that corresponds to the contour of the recesses 18, are pressed into the top 14 of the moisture absorption layer 12, whereby the plastic filaments that come into contact with the punches are melted due to the high temperature of the punches, so that the recesses 18 are formed. Because of the melting process of the plastic filaments, the recesses 18 are given a smooth bottom wall 20a and a smooth side wall 20b. The thickness d of the moisture absorption layer 12, i.e. of the tile laying mat 10 amounts to 3 mm in the present case. Fundamentally, however, the thickness can lie in a range between 1 and 5 mm. If, for example, a floor structure having a low height is standing in the foreground, then a low thickness d is recommended. If, in contrast, a good insulation function is of particular importance, then the selection of a greater thickness d is recommended.

In order to lay tiles 22 on a substratum 24, which can be a floor or wall substratum, first a tile adhesive layer 26 is applied to the substratum 24, as shown in FIG. 3. Subsequently, the tile laying mat 10 is pressed onto the tile adhesive layer 26 with the underside 16 of the moisture absorption layer 12, whereby tile adhesive partly penetrates into the interstices that are present between the plastic filaments of the moisture absorption layer 12, and encloses the plastic filaments, so that the moisture absorption layer 12 is firmly connected with the substratum 24 after the adhesive has dried, by way of the tile adhesive layer 26. Subsequently, another tile adhesive layer 28 is applied to the top 14 of the moisture absorption layer 12. In this connection, the tile adhesive partly penetrates into the nonwoven on the top 14 of the moisture absorption layer 12, thereby also producing a firm connection between the tile adhesive layer 28 and the moisture absorption layer after the tile adhesive has dried. Furthermore, the tile adhesive 28 that has been applied to the top 14 of the moisture absorption layer 12 penetrates into the recesses 18 and fills them completely. Because of the smooth bottom and side walls 20a, 20b of the recesses 18, however, no firm connection between the tile adhesive and the walls 20a, 20b of the recesses 18 is produced, in contrast to the top 14. In a subsequent step, the tiles 22 can now be laid onto the tile adhesive layer 28, in order to complete the floor composite 30 shown in FIG. 3 in this manner.

Because of the fact that the moisture absorption layer 12 of the tile laying mat 10 is configured to be moisture-permeable, moisture that is present in the substratum 24 and in the lower tile adhesive layer 26 can enter into the moisture absorption layer 12 through the underside 16, and moisture that is present in the upper tile adhesive layer 28 can enter into it through the top 14. Accordingly, the substratum 24 as well as the tile adhesive layers 26 and 28 can dry out completely and harden, without any problems, whereby the moisture that has been removed is collected in the moisture absorption layer 12, and drained off by way of it, if necessary.

The adhesive that penetrates into the recesses 18 from above forms support stilts that extend from the top 14 of the moisture absorption layer 12 in the direction of the underside 16, but do not pass through the latter, whereby the support stilts rest against the substratum 24 or the tile adhesive 26, compressing the nonwoven of the moisture absorption layer 12 that is present underneath them. Accordingly, there is no direct connection between the upper adhesive layer 28 and the lower adhesive layer 26, so that the adhesive layers 26, 28 are uncoupled from one another, and thus the substratum 24 is uncoupled from the tiles 22. Because of the smooth bottom and side walls 20a, 20b of the recesses 18, the support stilts are furthermore loosely accommodated in the recesses 18, so that they can move laterally, displacing the nonwoven of the moisture absorption layer 12 that is disposed adjacent to them. In this manner, tensions that exist between the substratum 24 and the tiles 22 can be compensated, and loosening of the tiles 22 as the result of such tensions can be prevented.

Furthermore, heat insulation and footstep noise insulation is achieved by means of the moisture absorption layer 12, which is configured in the manner of a nonwoven.

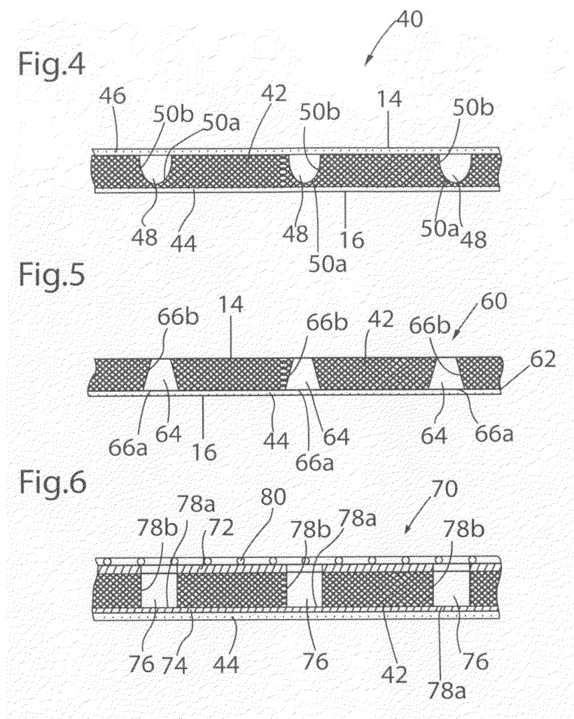

FIG. 4 shows a cross-sectional view of a tile laying mat 40 according to a second embodiment of the present invention. The tile laying mat 40 comprises a moisture absorption layer 42 that is formed from plastic filaments disposed crosswise relative to one another. Thus, the moisture absorption layer 42 comprises a regular structure configured in the manner of a brush, which demonstrates relatively great strength due to the orientation of the plastic filaments. Accordingly, the moisture absorption layer 42 cannot be compressed as easily as the moisture absorption layer 12 of the tile laying mat 10 shown in FIGS. 1 to 3, for example. The tile laying mat 40 furthermore comprises two attachment layers 44 and 46 made of nonwoven, which accommodate the moisture absorption layer 42 between them, and which are glued to it, in each instance. If tile adhesive is applied to these attachment layers 44 and 46 from the outside, then this adhesive wedges into the nonwoven, at least in part, thereby producing a firm connection between the adhesive layer and the corresponding attachment layer 44, 46, in the hardened state of the tile adhesive. The tile laying mat 40 furthermore comprises, analogous to FIG. 1, a plurality of recesses 48 that extend through the upper attachment layer 46 and the moisture absorption layer 42, in each instance. In contrast, the recesses 48 do not pass through the lower attachment layer 44. The recesses 48, analogous to FIG. 1, are regularly distributed over the entire top of the tile laying mat 40, and have a circular cross-section that gradually narrows, proceeding from the upper attachment layer 46, in the direction of the lower attachment layer 44, as can be seen in FIG. 4. Just like the recesses 18 of the tile laying mat 10, the recesses 48 of the tile laying mat 40 have smooth bottom walls 50a and smooth side walls 50b, thereby preventing an adhesive connection between the walls 50a, 50b of the recesses 48 and a tile adhesive disposed in the recesses 48.

If now (analogous to FIG. 3) tiles 22 are to be laid on a substratum 24, using the tile laying mat 40, first, again, a tile adhesive layer 26 is applied to the substratum 24. Then, the tile laying mat is pressed onto the tile adhesive layer 26 with the lower attachment layer 44, so that the tile adhesive penetrates into the nonwoven of the attachment layer 44, at least in part, and encloses it, so that in the hardened state of the tile adhesive, a firm connection between the tile adhesive layer 26 and the attachment layer 44 is produced. Then an additional tile adhesive layer 28 is applied to the top of the upper attachment layer 46 of the tile laying mat 40, whereby the tile adhesive partly penetrates into the nonwoven of the upper attachment layer 46, so that there, a corresponding firm connection is produced. Furthermore, the tile adhesive penetrates into the recesses 48 of the tile laying mat 40 and fills them completely. Because of the smooth bottom and side walls 50a, 50b of the recesses 48, however, an adhesive connection between tile adhesive and the bottom and side walls 50a, 50b of the recesses 48 is prevented.

The drainage, uncoupling, and insulation functions are implemented analogous to the structure described making reference to FIG. 3.

FIG. 5 shows a cross-sectional view of a tile laying mat 60 according to a third embodiment of the present invention. The tile laying mat 60 comprises a moisture absorption layer 42 as described above, making reference to FIG. 4. Furthermore, an intermediate layer 62 is adhesively held on the underside of the moisture absorption layer 42. In the present case, this intermediate layer is a moisture-permeable woven fabric layer that does not enter into any adhesive connection with tile adhesive when it comes into contact with such an adhesive. Again, an attachment layer 44 is attached on the underside of the intermediate layer 62, as was previously described with reference to the second embodiment. Furthermore, the tile laying mat 60 comprises a plurality of regularly distributed recesses 64 analogous to FIG. 1. These recesses 64 extend through the entire moisture absorption layer 42 and comprise a round cross-section that widens, proceeding from the top 14 of the moisture absorption layer 42, in the direction of the underside 16, so that truncated cone shapes are formed. Alternatively, here, a configuration in the form of a truncated pyramid or the like would also be possible. Accordingly, the recesses 64, viewed from above, form undercuts in which tile adhesive introduced into the recesses 64 can wedge itself. Thus, the upper attachment layer shown in FIG. 4 can be eliminated. The recesses 64 also have smooth bottom and side walls 66a, 66b, which, together with the intermediate layer 62, prevent adhesive anchoring of tile adhesive within the recesses 64.

The drainage, uncoupling, and insulation functions are implemented analogous to the structure described making reference to FIG. 3.

FIG. 6 shows a cross-sectional view of a tile laying mat 70 according to a fourth embodiment of the present invention. The tile laying mat 70 comprises a moisture absorption layer 42, as it was previously described making reference to FIG. 4. A woven upper cover textile layer 72 and a woven lower cover textile layer 74 are firmly connected with the top 14 and the underside 16 of the moisture absorption layer 42, so that the moisture absorption layer 42 is enclosed between the cover textile layers 72 and 74 in the manner of a spacer knitted fabric and forms what is called a pile layer. The tile laying mat 70 furthermore comprises a plurality of recesses 66 analogous to FIG. 1, which extend through the upper cover textile layer 72 and the moisture absorption layer 42. The recesses 76 are configured in cylinder shape and comprise smooth bottom and side walls 78a, 78b, which do not enter into any adhesive connection with tile adhesive. The woven fabric cover layers 72 and 74 also do not enter into any adhesive connection with tile adhesive. For this reason, an attachment layer 44 is attached to the lower cover layer 74, as was already explained making reference to FIG. 4, in order to be able to glue the tile laying mat 70 in place on a substratum, using a tile adhesive. Furthermore, an attachment lattice is glued onto the upper cover textile layer 72, the mesh width of which lattice is of such a size that the tile adhesive applied to the tile laying mat 70 can easily penetrate the attachment lattice 80 and fill the recesses 76. This attachment lattice 80 ensures a firm adhesive connection between the tile adhesive and the top of the tile laying mat 70, in order to be able to produce a proper floor composite in this manner.

The drainage, uncoupling, and insulation functions are implemented analogous to the structure described making reference to FIG. 3.

The moisture absorption layers 12 and 42 of the tile laying mats 10, 40, 60, and 70 of the embodiments described above are configured to be not only moisture-permeable but also moisture-wicking and moisture-equalizing. Furthermore, they are configured to be air-permeable, heat-insulating, and noise-insulating.

It should be clear that the embodiments described above serve only as examples and are not intended to be restrictive in any way. In particular, it should be pointed out that in order to achieve the uncoupling effect, all that is required is that the bottom walls of the recesses do not enter into an adhesive connection with the tile adhesive. Accordingly, the side walls of the recesses can also have a rough surface, without any significant impairment of the uncoupling effect. Also, both the bottom walls and the side walls of the recesses can have a rough surface, so that they enter into an adhesive connection with the tile adhesive that enters into the recesses. However, this occurs at the expense of the uncoupling effect of the tile laying mat, and for this reason, at least smooth bottom walls are preferred. Furthermore, it should be clear that the moisture absorption layers of the individual tile laying mats can have not only plastic filaments but also natural material filaments, metal filaments, metal filaments mantled with plastic, or the like. Also combinations of filaments having different shapes and made from different materials, for example made of open-pore foamed material, are possible. Furthermore, the recesses can have any desired cross-sectional shape, such as, for example, polygonal, round, or oval cross-sections. Furthermore, the rigidity of the tile laying mat according to the invention, in the thickness direction, is preferably selected in such a manner that the tile laying mat can at least absorb the inherent weight of the adhesive layer disposed on top of it, as well as of the tiles, without experiencing any significant compression in the thickness direction. Accordingly, it is prevented that the cavity made available by the moisture absorption layer, for absorbing moisture, is reduced in size during drying of the adhesive, due to the inherent weight of the adhesive layer and the tiles. After the adhesive has dried, the support stilts prevent compression of the moisture absorption layer.

The term “adhesive” means all types of adhesive or mortar suitable for attaching the tile laying mat and/or attaching the hard floor coverings referred to as tile, in each instance.

Reference Symbol List

| | |
|---|---|
| 10 | tile laying mat |
| 12 | moisture absorption |
| | layer |
| 14 | top |
| 16 | underside |
| 18 | recess |
| 20a | bottom wall |
| 20b | side wall |
| 22 | tile |
| 24 | substratum |
| 26 | tile adhesive layer |
| 28 | tile adhesive layer |
| 30 | floor composite |
| 40 | tile laying mat |
| 42 | moisture absorption |
| | layer |
| 44 | attachment layer |
| 46 | attachment layer |
| 48 | recess |
| 50a | bottom wall |
| 50b | side wall |
| 60 | tile laying mat |
| 62 | intermediate layer |
| 64 | recess |
| 66a | bottom wall |
| 66b | side wall |
| 70 | tile laying mat |
| 72 | upper cover layer |
| 74 | lower cover layer |
| 76 | recess |
| 78a | bottom wall |
| 78b | side wall |
| 80 | attachment lattice |
| d | thickness |

1. Moisture-permeable tile laying mat (10; 40; 60; 70) having a moisture absorption layer (12; 42) having a thickness of at least 1 mm, whereby the tile laying mat (10; 40; 60; 70) has a top (14) and an underside (16) as well as a plurality of recesses (18; 48; 64; 76) that extend in the direction of the underside (16), proceeding from the top (14).

2. Tile laying mat (10; 40; 60; 70) according to claim 1, wherein the moisture absorption layer (12; 42) is configured in the manner of a nonwoven or a woven fabric.

3. Tile laying mat (10; 40; 60; 70) according to claim 1, wherein the moisture absorption layer (12; 42) is formed from plastic filaments configured to be the same or different, preferably from polyester filaments.

4. Tile laying mat (10; 40; 60; 70) according to claim 3, wherein the plastic filaments are disposed in regular or irregular manner.

5. Tile laying mat (10; 40; 60; 70) according to claim 1, wherein the recesses (18; 48; 64; 76) are uniformly distributed over the total area of the tile laying mat (10; 40; 60; 70).

6. Tile laying mat (10; 40; 60; 70) according to claim 1, wherein the bottom and/or side walls (20a, 20b; 50a, 50b; 66a, 66b; 78a; 78b) of the recesses (18; 48; 64; 76) are at least partly configured in such a manner that no adhesive connection between them and a tile adhesive introduced into the recesses (18; 48; 64; 76) comes about.

7. Tile laying mat (10; 40; 60; 70) according to claim 1, wherein an attachment layer (44; 46; 80) for attaching the tile laying mat (10; 40; 60; 70) is connected with the underside and/or the top of the moisture absorption layer (12; 42), particularly glued to it.

8. Tile laying mat (10; 40; 60; 70) according to claim 7, wherein the underside or the top of the attachment layer (44; 46; 80) is configured in such a manner that it enters into an adhesive connection for attaching the tile laying mat (40; 60; 70) with a tile adhesive.

9. Tile laying mat (10; 40; 60; 70) according to claim 7, wherein the attachment layer (44; 46; 80) has a nonwoven fabric, a woven fabric, or a lattice.

10. Tile laying mat (10; 40; 60; 70) according to claim 1, wherein the moisture absorption layer (12; 42) is a pile textile layer of a spacer knitted fabric disposed between a lower and an upper cover textile layer (72, 74).

11. Tile laying mat (10; 40; 60; 70) according to claim 10, wherein the underside of the lower cover textile layer (74) and/or the top of the upper cover textile layer (72) is/are configured in such a manner that it/they enter(s) into an adhesive connection with the tile adhesive for attaching the tile laying mat (10; 40; 60; 70).

12. Tile laying mat (10; 40; 60; 70) according to claim 11, wherein the underside of the lower cover textile layer (74) and/or the top of the upper cover textile layer (72) is/are configured in the manner of a nonwoven.

13. Tile laying mat (10; 40; 60; 70) according to claim 10, wherein an attachment layer (44; 46; 80) is connected with the underside of the lower cover textile layer (74) and/or with the top of the upper cover textile layer (72), particularly glued to it, whose underside or top is configured in such a manner that it enters into an adhesive connection with a tile adhesive, to attach the tile laying mat (10; 40; 60; 70).

14. Tile laying mat (10; 40; 60; 70) according to claim 13, wherein at least one side of the attachment layer (44; 46) is configured in the manner of a nonwoven.

15. Tile laying mat (10; 40; 60; 70) according to claim 1, wherein it has a thickness in the range of 1.5-5 mm.

16. Tile laying mat (10; 40; 60; 70) according to claim 1, wherein it is so flexible that it can be rolled up.

17. Tile laying mat (10; 40; 60; 70) according to claim 1, wherein it is configured to be so tear-resistant that it can be attached to walls and ceilings with attachment means, particularly with wall anchors and screws.

18. Method for the production of a tile laying mat (10; 40; 60; 70) according to claim 1.

19. Method according to claim 18, wherein the recesses of the moisture absorption layer (12; 42) are formed with partial melting of at least the moisture absorption layer (12; 42).

20. Method according to claim 19, wherein the recesses are formed in the tile laying mat using hot punches of a die mold.
